(19) United States
(12) Patent Application Publication
(10) Pub. No.: US 2008/0065487 A1
(43) Pub. Date: Mar. 13, 2008

(54) CONTEXTUAL CONTENT RENDERING

(75) Inventor: Matthew T. Shea, Mercer Island, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: WILDTANGENT, INC., Redmond, WA (US)

(21) Appl. No.: 11/849,091

(22) Filed: Aug. 31, 2007

Related U.S. Application Data
(60) Provisional application No. 60/825,061, filed on Sep. 8, 2006.

(51) Int. Cl. G06Q 30/00; A63F 9/24; G06F 17/30

(52) U.S. Cl. 705/14; 463/42

(57) ABSTRACT

Methods, apparatuses, and systems for executing by a processor of a device, an application, including rendering primary content on a display of the device and rendering secondary content on the display based at least in part on one or more attributes of the application.

### RELATED APPLICATIONS

This application claims the benefit of U.S. Provisional Application No. 60/825,061 filed Sep. 8, 2006.

### FIELD OF THE DISCLOSURE

The present invention relates to the field of electronic data/information processing. More specifically, the present invention relates to methods and devices for adapting content rendering, such as advertisements, based on attributes of an application such as ownership information or contextual information.

### BACKGROUND OF THE DISCLOSURE

A major challenge for advertisers is determining the cost effectiveness of the advertisements they place. In the online word, metrics such as number of “eyeballs”, “clicks” or “actions” have been developed to determine payment by the advertisers to the online sites in order to assure that advertisers are paying for effective rendering or communication of their content and messages through the online sites. Such metrics include measuring the number of online users who view an advertisement included with a webpage, the number of users who click on a hyperlink such as a Uniform Resource Locator (URL) embedded in a webpage to receive additional content, information, or offers, and measuring the number of users who purchase products or services from the advertisers as a result of taking such actions or viewing online content or advertisements, included with webpages, among other methods.

Concurrently, to improve effectiveness of the placed online advertisements, various techniques have been developed to tailor advertisement rendering based e.g. on other content of webpages being viewed and/or user demographics to ensure that advertisements are being rendered to a meaningful audience.

Recently, as games are catching up to, if not surpassing, television as the major form of entertainment, interest in advertising during game play has increased. Game play associated advertising faces the same cost effectiveness issues as online (webpage) advertising.

### BRIEF DESCRIPTION OF THE DRAWINGS

FIG. 1 illustrates an overview of a system for serving secondary contents in accordance with various embodiments;

FIG. 2 depicts a method for serving secondary contents in accordance with various embodiments; and

FIG. 3 illustrates an example computing system suitable for use to practice the invention, in accordance with various embodiments.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Embodiments may include serving messages and media distributed on behalf of one or more third parties, such as advertisements on behalf of advertisers, before, during and/or after the execution of an application, such as a game or other application which renders content. These third party messages and media may be associated with products or services not tied or related to the application or game or any party responsible for distribution of the application or game. In various embodiments, the serving may be based on application attributes that allow the system to compute or determine which message or messages would be most contextually relevant to the user. In embodiments, contextual relevance may be related to a measure of how likely a user of the application or game may be to take some action in response to the third party message or media; in particular, in embodiments, the likelihood that the user will ultimately purchase goods or services from the third party or others. In various embodiments, the serving of messages or media may be based on the ownership state of the application. Further, in various embodiments, the serving may be based on application attributes stored in secure storage of the platform, employed to control game distribution. In other embodiments, demographic information about the user may be used either alone or in combination with other attributes to tailor the secondary content shown to the user.

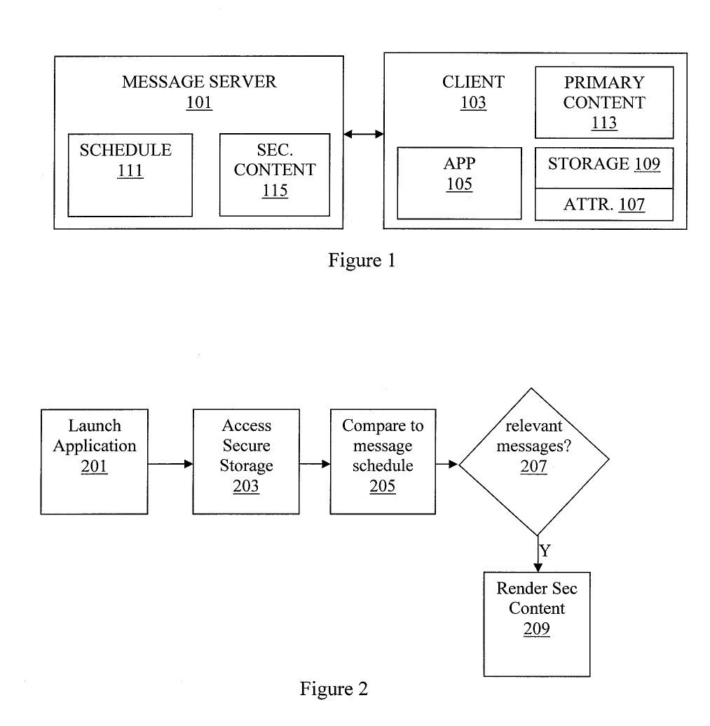

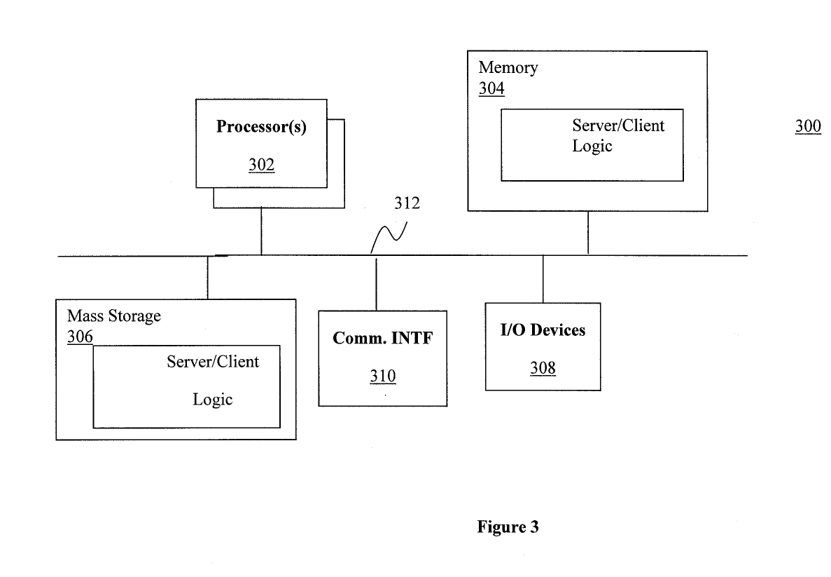

FIG. 1 illustrates an overview of a system for serving secondary content in accordance with various embodiments. Message server 101 and client device 103 are shown connected. This connection may be, for example, a wired or wireless connection. In embodiments, the connection may be via the Internet or other public or private network infrastructure. Embodiments of the present invention need not be limited to any one, or set of, connection types. Client 103 may be any device capable of executing an application such, as for example, a server, personal computer, laptop computer, handheld device, mobile telephone, handheld game device, personal data assistant (PDA), or other similar device. Similarly, message server 101 may be any device known in the art. An example of a computer system suitable to practice the present invention may be found in FIG. 3.

Message server 101 may include a stored message schedule 111 including information regarding which application attributes may be contextually relevant to secondary content 115. Secondary content 115 may include, in embodiments audio and/or video messages, advertisement messages, offer messages, coupon messages, graphical display messages, or other content messages. Advertisement messages as used herein include for profit as well as non-profit public service messages. Message schedule 111 and/or secondary content 115 may include instructions for each message contained within dictating a time or times that each message should be rendered; e.g. before, during, or after application execution. Client 103 may include, in embodiments, software application 105 (hereinafter, simply application) which may be, in embodiments, a game or gaming module of client 103. In other words, the term “game” as used herein refers to “electronic games” and/or “game software”. In embodiments where application 105 is a game, the instructions indicating a time or times the message or messages of secondary content 115 are to be rendered may indicate a level, event, sub-level, marker, or other indication of a moment during gameplay that the message or messages should be rendered. Client 103 may also contain primary content 113 which may, in embodiments, be accessed and rendered by application 105 during the course of execution of application 105. In embodiments where application 105 is a game or game player, primary content 113 may be game content. Application 105 may also be capable of rendering secondary content. In embodiments, client 103 may contain secure storage 109 which may contain, among other things, application attributes 107.

In embodiments, client 103 may retrieve application attributes 107 and send a request to message server 101 which includes application attributes 107; message server 101 may respond by returning a collection of messages from secondary content 115 each with data describing how client 103 should decide if and when to render the returned messages. Client 103 may then temporarily store the contextually relevant messages and render them at the appropriate time. For example, the information may indicate that client 103 should render the returned messages before, during, or after application 105 execution. In embodiments, client 103 may render one or more of the returned messages after a certain event during execution of application 105. In embodiments where application 105 is a game, message rendering may occur once a user reaches a certain level, obtains a virtual item, or reaches some other event within the course of gameplay.

Message server 101 may, in embodiments, access message schedule 111 and match up received attributes 107 with information regarding secondary content 115 to determine or compute which of one or more messages contained within secondary contents 115 are most contextually relevant to received attributes 107.

In alternate embodiments, client 103 may store message schedule 111 and/or secondary content 115 locally. In embodiments, client 103 may retrieve message schedule 111 and/or secondary content 115 from message server 101 at predetermined intervals, a single time, or each time client 103 is online, or other times. In embodiments where message schedule 111 is stored locally, client 103 may access storage 109 to retrieve attributes 107 in order to perform its own computation or determination as to which messages are contextually relevant. In embodiments, client 103 may then retrieve the messages from message server 101 or from a locally stored copy of secondary contents 115. In embodiments, client 103 may use a locally stored copy of secondary content 115 and/or message schedule 111 when client 103 is offline, and request message server 101 return a list of contextually relevant messages when client 103 is online. One of ordinary skill will recognize that other variations of storage and retrieval are possible without departing from the scope of the invention. For example, secondary contents may be stored in a group of distributed servers, or on a peer-to-peer network of participating devices.

A critical aspect of selling games distributed over the Internet may be the ability to securely store data that controls the licensing of the game, including data reflective of the ownership state of the game. Such licensing, or digital licensing, has traditionally been responsible for controlling access to the game and signifying if and when the user must buy the game or otherwise tender further payment, monetary or non-monetary currency, for further access.

Secure storage of attributes 107, including attributes for the purposes of licensing/ownership, may, in embodiments, be achieved through both local storage (such as secure storage 109) and remote storage, depending on the characteristics of the given game. For example, a single player game that must work offline may store attributes on the user's machine in a secure manner, such as in secure storage 109. In the case of a multiplayer game, the storage of attributes may be in a remote system separate from the user's machine. In embodiments, a hybrid storage scheme is possible, wherein attributes may be stored locally and updated when a client device is online. In the case of secure storage of attributes in secure storage 109, encryption and obfuscation techniques may be utilized to prevent non-trusted entities from viewing and modifying the data.

In embodiments, client 103 may receive from message server 101, messages to be played along with information as to the appropriate time to render the messages to the user such as, for example, before, during, or after application 105 execution or gameplay. In embodiments, such information may serve to maximize the contextual relevance of the received messages. Client 103 may access secure storage 109 to retrieve attributes 107 in order to compare them to the information from message server 101 in order to determine a time or times to render the received messages. In embodiments, client 103 may compare data other than attributes 107 to the included information. In embodiments, data and/or attributes used to compare may include a game level, the number of times a user has accessed a game or a game level, ownership information, whether the application is purchased, whether the application is a free version, and others.

The method by which a user pays for access to application 105—including when application 105 is a game—may be stored in storage 109 which may be a secure storage system. For example, if the user bought the application or has gained access by allowing an advertiser to pay for a given session, as indicated by attributes 107 stored in storage 109, message schedule 111 may include only messages scheduled from the advertiser who has paid for the session; alternatively no scheduled third party messages may be included. In embodiments where attributes 107 indicate that the user has been provided with free access to the application or game, message schedule 111 may include one or more messages scheduled against such an attribute. In embodiments, messages may be scheduled against attributes indicating that a user has paid for a relatively lower level of access but not against attributes indicating that a user has paid for a relatively higher level of access.

In embodiments where application 105 is a game broken apart into levels, the progress of the levels visited by the user may be stored in storage 109. At a certain level of the game, the user may see and interact with a certain virtual item having a real-world analogue and the user's interaction with the certain virtual item may then also be stored in storage 109. For example, a cell phone may be acquired by a user in a certain level and message schedule 111 may include a message from a cell phone service provider scheduled against an attribute indicating that the user has interacted with the virtual cell phone. In this example, message schedule 111 may include a scheduled message from a cell phone service provider. In embodiments, message schedule 111 may schedule a message for a vacation package against an attribute indicating that a user has a propensity to play a certain level of a game, such as e.g. the user has played the level a certain number of times, where the level is a virtual facsimile of a real-world locale.

In embodiments, a message may be scheduled against an attribute indicating that the user has accessed application 105 more than a certain number of times. In embodiments, messages may be for the purpose of promoting third party products and/or services, and may not be tied to the existing application or game that the user is executing or playing. In embodiments, messages may include the rendering of a movie preview for an upcoming movie.

FIG. 2 depicts a method for serving secondary content in accordance with various embodiments. First an application, such as a game or other application, may be launched 201. The application may access secure storage 203 to retrieve application attributes. In embodiments, attributes may be stored in some other type of storage. In embodiments, attributes may be generated by the application as the application is executed, generated by user input, or generated by the user's interaction with the application. Such attributes may include, for example, the number of times a user accesses a certain portion of the application (such as a level of a game), a virtual item possessed by the user within a context of a computer game, etc.

Attributes may then be compared to a message schedule 205 which may contain cross references of messages with contextual information indicating a prediction of the circumstances under which the messages may be most contextually relevant. In embodiments, contextual relevance may represent a prediction of how likely a user may be to respond to a message by taking certain actions, such as ultimately purchasing services and/or products advertised in the messages. The comparison of application attributes to the message schedule 205 may include, among other things, determining which attributes match up with the contextual information contained within the message schedule. In embodiments, the comparison 205 may include determining if any messages are scheduled against the received attributes. In embodiments, the message schedule may be stored on a message server which may be separate from a client device that the application or game is executed on.

Next, a determination may be made as to whether one or more messages are contextually relevant 207. If so, contextually relevant messages may be provided to the client device and rendered 209 on the client device at an appropriate time. In various embodiments, the contextually relevant messages may be rendered before, during, or after application execution or game play. In embodiments, only a subset of the attributes may be used to determine contextual relevance.

In embodiments, no secondary content or messages may be scheduled if the attributes indicate that the user owns the application or game. In embodiments, advertisements may be rendered if the user has obtained a free version of the application or game. In embodiments, other attributes besides ownership information may be used to determine which messages or secondary content is contextually relevant. In embodiments where the application or game is a free version, such an attribute may be necessary, but not sufficient, to determine contextual relevance and to render a message or secondary content.

FIG. 3 illustrates an example computing system/device suitable for use to practice the client device and/or server of FIG. 1, in accordance with one embodiment. As shown, computing system/device 300 may include one or more processors 302, and system memory 304. Additionally, computing system/device 300 may include mass storage devices 306 (such as diskette, hard drive, CDROM and so forth), input/output devices 308 (such as keyboard, cursor control and so forth) and communication interfaces 310 (such as network interface cards, modems and so forth). The elements may be coupled to each other via system bus 312, which represents one or more buses. In the case of multiple buses, they may be bridged by one or more bus bridges (not shown).

Each of these elements performs its conventional functions known in the art. In particular, system memory 304 and mass storage 306 may be employed to store a working copy and a permanent copy of the programming instructions implementing one or more aspects of the above described teachings to practice the present invention. In various embodiments, system memory 304 and/or mass storage 306 may also be employed to securely store the game attributes, including e.g. licensing/ownership related attributes. The programming instructions may also implement other related functions. For example, in the case of computing system/device 300 being used as a client device 103 of FIG. 1, the programming instructions may also implement telephony, PIM applications and so forth. When computing system/device 300 is being used as a server, the programming instructions may also implement accounting and other ad services related functions. The programming instructions may be implemented in assembler instructions supported by processor(s) 302 or high level languages, such as C or Java, that can be compiled into such instructions, or instructions for a virtual machine (VM) operating on the processor(s), memory, and software systems of the computing system/device.

The permanent copy of the programming instructions may be placed into permanent storage 306 in the factory, or in the field, through e.g. a distribution medium (not shown) or through communication interface 310 (from a distribution server (not shown)). The constitution of these elements 302-312 are known, and accordingly will not be further described.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein.

What is claimed is:

1. A method comprising:
executing by a processor of a device, an application, including rendering primary content on a display of the device; and
rendering secondary content on the display based at least in part on one or more attributes of the application.

2. The method of claim 1 wherein the application is a game and the primary content is game content.

3. The method of claim 1 wherein the secondary content comprises an advertisement.

4. The method of claim 1 wherein the application comprises a game and the one or more attributes comprise whether the game was purchased.

5. The method of claim 1 wherein the application comprises a game and the one or more attributes comprise whether the game was paid for by an advertiser.

6. The method of claim 1 wherein the one or more attributes are each capable of being changed from a first state to a second state over time.

7. The method of claim 6 wherein the first state comprises the application is a free version and the second state comprises the application has been purchased.

8. The method of claim 1 wherein the attribute is stored in a secured storage of the device.

9. The method of claim 1 wherein the advertisement is a member of a message schedule, and the method further comprises analyzing the message schedule in light of the attributes.

10. The method of claim 1 wherein the application is a game and the attributes comprise one or more of a level, sub-level, game event, game marker, the number of times the game has been executed, and the number of times a level of the game has been initiated.

11. A method comprising:
executing by a processor of a device, a game, including rendering game content on a display of the device; and
rendering secondary content on the display based at least in part on one or more attributes of the game.

12. The method of claim 11 wherein the secondary content comprises an advertisement.

13. The method of claim 11 wherein the attributes comprise whether the game was purchased.

14. The method of claim 11 wherein the attributes include the game was purchased at a first time and the game is a free version at a second time.

15. An apparatus comprising:
a display;
a processor operatively coupled to the display;
a storage medium including primary content, and
a plurality of programming instructions stored in the storage medium to program the processor to:
render primary content on a display of the device; and
render secondary content on the display based at least in part on one or more attributes of an application.

16. The apparatus of claim 15 wherein the secondary content comprises an advertisement.

17. The apparatus of claim 15 wherein the attributes are capable of being changed from a first state to a second state over time, and wherein the plurality of programming instructions is further adapted to implement the application and wherein the first state comprises the application is a free version and the second state comprises the application has been purchased.

18. The apparatus of claim 15 further comprising a network device and wherein the plurality of programming instructions are further adapted to send, to a message server via the network device, one or more of the attributes and to receive, via the network device, the secondary content.

19. A server comprising:
a storage device;
a processor coupled to the storage device; and
a plurality of programming instructions stored on the storage device to program the processor to:
receive one or more application attributes of an application from a client device; and
send secondary content to the client device based at least in part on the received one or more attributes of the application.

20. The server of claim 19 wherein the plurality of programming instructions are further adapted to program the processor to compare the received one or more application attributes to a message schedule to determine the secondary content to be sent to the client device, and wherein the message schedule includes a list of secondary content messages and cross references to application attributes.

21. The server of claim 19 wherein the application comprises a game and the attribute comprises whether the game was purchased.

22. The server of claim 19 wherein the one or more attributes are each capable of being changed from a first state to a second state over time.

23. An apparatus comprising:
a display;
a processor operatively coupled to the display;
a storage medium including primary content, and
a plurality of programming instructions stored in the storage medium to program the processor to:
execute a game including the rendering of game content on a display of the device; and
render secondary content on the display based at least in part on one or more attributes of the application.

24. The apparatus of claim 23 wherein the secondary content comprises an advertisement and wherein the one or more attributes comprise either the game was purchased or the game was free.

25. The apparatus of claim 23 further comprising a network device and wherein the plurality of programming instructions are further adapted to send, to a message server via the network device, one or more of the attributes and to receive, via the network device, the secondary content.
